(19) United States
(12) Patent Application Publication
(10) Pub. No.: US 2002/0152132 A1
(43) Pub. Date: Oct. 17, 2002

(54) Ordering/order receiving system for color matching paint and server computer for intermediary

(76) Inventors: Tohru Hirayama, Chigasaki-shi (JP); Shinichi Gamou, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/089,882

(22) PCT Filed: Aug. 6, 2001
(86) PCT No.: PCT/JP01/06747

(30) Foreign Application Priority Data
Aug. 7, 2000 (JP) 2000-238579
Aug. 22, 2000 (JP) 2000-251616

(51) Int. Cl. G06F 17/60

(52) U.S. Cl. 705/26

(57) ABSTRACT

Toning operations can be separated from a painting site by giving an order for toning operations to a toning person through a network. An orderer prepares a toning job including the calorimetric data nearby a repair portion, the type and a necessary quantity of paint, and the date of delivery and transmits the job to a selected toning person (1). The toning person checks an allowable limit of toning based on a designated paint, then prepares a toned paint (3) and sends the toned paint to the orderer by a home delivery service of packages or the like (5) A painter performs test painting with a supplied paint (6). When the test painting is OK, the painter actually performs painting with the paint. It is also allowed for an agent to select a toning person on-line. Moreover, it is allowed for the agent to select a toning person through tender on-line.

### TECHNICAL FIELD

The present invention relates to a toned-paint order-giving and supplying method and a toned-paint order-giving and order-receiving method to be executed through a computer and a toned-paint order-giving, and an order-receiving system used for the method and a server computer used for the system.

### BACKGROUND ART

Conventionally, when performing repair painting of a perfectly-finished paint film such as an automobile paint film, a toned paint has been prepared in a repair-painting site such as an automobile repair-painting factory and provided for repair painting in general. Therefore, in a repair-painting site, it has been necessary to keep primary-color paints for toning and manage stocks, secure expert toning persons, and set a computer toning system. Moreover, there have been problems that even if a computer toning system is set, paint attaches to a painting site and the painting site is easily contaminated and if cleaning is insufficient, computer toning cannot be accurately performed.

Moreover, when a painter (paint orderer) has given an order for a toned paint to a toning person, because it has been necessary to send a reference plate for toning a color from the painter to the toning person, there have been problems of time loss and transport cost and therefore, a quick paint-order-giving method advantageous in cost has been requested.

It is an object of the present invention to provide a quick and cost-advantageous toned-paint order-giving and supplying method capable of separating a toning operation from a repair-painting site, eliminating the toning operation from a painting site, separately obtaining a toned paint, and providing the paint for painting. It is another object of the present invention to eliminate a toning operation from a repair-painting side and solve the above problems on toning.

### DISCLOSURE OF THE INVENTION

The present inventors find that the above objects can be achieved by the fact that a paint orderer (painter) gives an order for a toning job to a selected toning person through a computer terminal the toning person receiving the order prepares and supplies a toned paint, and complete the present invention.

That is, the present invention provides a paint ordering and supplying method including:

(1) a step of allowing a paint orderer to input a toning job including the calorimetric data of a reference color with which the color of a paint should be matched through toning and the data of the type and a necessary quantity of the paint to a computer terminal;

(2) a step of selecting a toning person, connecting the computer terminal to the computer of the selected toning person, and transmitting the toning job to the selected toning person to give an order for the toning job to the toning person;

(3) a step of allowing a toning person to communicate the order-receiving approval of the toning job to the paint orderer and prepare a toned paint matched with the toning job; and

(4) a step of supplying the toned paint from the toning person to the paint orderer.

Moreover, the present invention provides the above method further including (2a) a step of allowing a toning person to estimate an allowable limit of toning by a designated type of paint through computer toning using a color-matching computation logic, transmit the data of the allowable limit of toning by the designated type of paint to a computer terminal of a paint orderer, and receive the approval of change to a toning job within the allowable limit of towing by the designated type of paint from the paint orderer after the above step (2), characterized in that the toning person prepares a toned paint suitable for the change-approved toning job in the above step (3).

Furthermore, the present invention provides the above method further including (5) a step of allowing a painter to prepare a test paint plate by test-painting the plate with the toned paint supplied by the above step (4), obtain the colorimetric data of the test paint plate, compare the colorimetric data of the test paint plate with a reference color, and determine whether the criterion of the toning end point is satisfied.

Furthermore, the present invention provides the above method characterized by repeating (6) a step of displaying painting conditions which may satisfy the criterion of the toning end point by the above computer and for a painter to prepare a test paint plate again by test-painting the plate with a toned paint in the same step as the above step (5), compare the calorimetric data of the test paint plate with a reference color by the computer, and determine whether the criterion of the toning end point is satisfied until the criterion of the toning end point is satisfied.

Furthermore, the present invention provides the above method characterized in that a computer compares the colorimetric data of a test paint plate with a reference color and determines that the criterion of the toning end point is satisfied, and then a painter performs full-scale painting.

Furthermore, the present inventors find that the above objects can be achieved by the fact that a paint orderer (painter) enters and gives an order for a toning job through a server computer of an agent and a toning person receiving the order for the toning job prepares and supplies a toned paint, and complete the present invention.

That is, the present invention provides a toned-paint order-giving and supplying method including:

(1) a step of allowing a paint orderer to input the colorimetric data of a reference color with which the color of a paint should be matched through toning and the type and a necessary quantity of the paint to a computer terminal connect the computer terminal to a server computer of an agent, and enter a toning job;

(2) a step of allowing the agent to select a toning person and give an order for the toning job to the selected toning person;

(3) a step of allowing the agent to obtain an order-receiving approval from the toning person and transmit an order-receiving decision to a computer terminal of the paint orderer;

(4) a step of allowing the toning person to prepare a toned paint corresponding to the content of the toning job; and

(5) a step of supplying the toned paint to the paint orderer.

Moreover, the present invention provides the above toned-paint order-giving and supplying method further including (1a) a step of allowing an agent to estimate an allowable limit of toning by a designated type of paint through the computer toning using a color-matching computation logic about the content of a toning job, transmit the data of the allowable limit of toning by the designated type of paint to a computer terminal of a paint orderer, and receive the approval of change to the toning job within the allowable limit of toning from the paint orderer after the above step (1), characterized in that the agent selects a toning person and gives an order for the change-approved toning job to the selected toning person.

Furthermore, the present invention provides the above toned-paint order-giving and supplying method further including (6) a step of allowing a painter to prepare a test paint plate by test-painting the plate with the toned paint supplied by the above step (5), obtain the calorimetric data of the test paint plate, compare the colorimetric data of the test paint plate with a reference color by a computer, and determine whether the criterion of the toning end point is satisfied.

Furthermore, the present invention provides the above order-giving and supplying method characterized by repeating (7) a step of displaying painting conditions which may satisfy the criterion of the toning end point by a computer and allowing a painter to prepare a retest paint plate by test-painting a toned paint in the same step as the above step (6) under the painting conditions, compare the colorimetric data of the retest paint plate with a reference color, and determine whether the criterion of the toning end point is satisfied until the criterion of the toning end point is satisfied when the criterion of the toning end point is not satisfied in the above step (6).

Furthermore, the present invention provides the above order-giving and supplying method characterized in that a computer compares the calorimetric data of a test paint plate with a reference color and determines that the criterion of the toning end point is satisfied and then, a painter performs full-scale painting.

Furthermore, the present invention provides a toned-paint order-giving and order-receiving method including:

(1) a step of allowing a paint orderer to input the colorimetric data of a reference color with which the color of a paint should be matched through toning and the type and a necessary quantity of the paint to a computer terminal, connect the computer terminal to a server computer of an agent, and enter a toning job;

(2) a step of allowing the agent to select a toning person and give an order for the toning job to the selected toning person; and

(3) a step of allowing the agent to obtain an order-receiving approval from the toning person and transmit an order-receiving decision to a computer terminal of the paint orderer.

Furthermore, the present invention provides a toned-paint order-giving and order-receiving system including:

(a) a paint-orderer's computer terminal in which a toning job including the information about the calorimetric data of a reference color with which the color of a paint should be matched through toning and the type and a necessary quantity of the paint are input;

(b) an agent's server computer in which the toning job sent from the paint-orderer's computer terminal is entered and which gives an order for the toning job to a toning person selected out of toning person data and transmits the order-receiving decision of the toning person to the paint-orderer's computer terminal; and

(c) a toning person's computer terminal for transmitting the order-receiving approval of the toning person about the toning job to the agent's server computer; characterized in that the computer terminal (a), server computer (b), and computer terminal (c) are connected each other by a communication line.

Furthermore, the present invention provides an agent's server computer in which a toning job from a paint orderer including the information about the calorimetric data of a reference color with which the color of a paint should be matched through toning, the type of the paint, and a necessary quantity of the paint is entered and which selects a toning person out of the toning person data including order backlogs of a plurality of toning persons and a distribution state from a toning place up to the paining place of the paint orderer, gives an order for the entered toning job to the selected toning person through the toning person's computer terminal, and moreover receives the toning person's order-receiving approval about the ordered toning job, and transmits an order-receiving decision to a computer terminal of the paint orderer.

### BRIEF DESCRIPTION OF THE DRAWINGS

FIG. 1 is a schematic illustration showing a toned-paint order-giving and supplying method of the present invention;

FIG. 2 is an illustration showing a flow of operations to be performed by a paint orderer in steps (1) and (2) of a method of the present invention;

FIG. 3 is an illustration showing a flow of operations to be performed by a toning person receiving an order for a toning job;

FIG. 4 is an illustration showing a flow of operations to be performed by a painter when examining a toned paint supplied from a toning person;

FIG. 5 is a schematic illustration showing a toned-paint order-giving and supplying method of the present invention;

FIG. 6 is an illustration showing a flow of operations to be performed by a paint orderer in step (1);

FIG. 7 is an illustration showing a flow of operations to be performed by an agent (center server) in steps (2) and (3);

FIG. 8 is an illustrations showing a flow of operations to be performed by a toning person approving the reception of an order for a toning job; and

FIG. 9 is an illustration showing a flow of operations to be performed by a painter when examining a toned paint supplied from a toning person.

### BEST MODE FOR CARRYING OUT THE INVENTION

A toned-paint order-giving and supplying method of the present invention includes a first invention method to fourth invention method. First, the first invention method is described below.

The first invention method includes the following steps (1) to (4).

Step (1)

Step (1) is a step of allowing a paint orderer such as a repair painter to input the colorimetric data of a reference color with which the color of a paint should be matched through toning, the type of the paint, and a necessary quantity of the paint, and if necessary, the date of delivery, the gloss of a paint film, micro-brilliant-feeling data, and a toning class to a computer terminal.

In the case of repair painting such as automobile repair painting, when forming a paint film by painting a toned paint, it is necessary that the difference between colors of the paint film of a repair painting portion and the pain film nearby the repair painting portion cannot be easily visually observed. Therefore, it is usually preferable that the above reference color is the color of the surface of a paint film nearby the repair painting portion.

It is allowed that the calorimetric data of a reference color is the data measured by a colorimeter that performs measurement at one angle. However, it is more preferable to use the data measured by a multi-angle colorimeter because it is possible to obtain higher-accuracy data.

A paint color is measured by a multi-angle colorimeter under two or more angular conditions, that is, different incident angles of measuring light or different light-receiving angles each of which is an angle formed between a mirror reflection axis and a light-receiving axis. The mirror reflection axis is an axis for forming a reflection angle when an incident angle is equal to the reflection angle such as an axis having a reflection angle of 45° when an incident angle is equal to 45°.

To change light-receiving angles, the angular conditions are not restricted. However, the following angular conditions are preferable because it is possible to easily correspond to visual determination of a color: in the case of two angular conditions, the above light-receiving angles must be equal to one angle in the range between 15° and 30° and one angle in a range between 75° and 110°; in the case of three angular conditions, the above light-receiving angles must be equal to one angle in a range between 15° and 30°, one angle in a range between 35° and 60°, and one angle in a range between 75° and 110°; and in the case of four angular conditions, the above light-receiving angles must be equal to one angle in a range between 15° and 30°, one angle in a range between 35° and 60°, one angle in a range between 70° and 80°, and one angle in a range between 90° and 110°.

It is allowed that measured values (angular criterion measured values) obtained by measuring the above reference color under various angular conditions are any values as long as the values can specify a color, that is, the values can show or compute lightness, chroma, and hue. For example, the values can be shown by the XYZ color system (X,Y,Z), Hunter Lab color system (L, a, and b values), L*C*h color system (L* value, C* value, and h value) specified in the CIE (1994), or Munsell color system (H, V, and C). Above all, the display according to the L*a*b * color system or L*C*h color system is generally used for the color display in industrial fields including the automobile repair painting field The gloss of a paint film input according to necessity is measured according to necessity when it is a frosting paint film, which shows the specular gloss specified in JIS K-5400 7.6 (1990) and can be measured by a glossimeter at various light reflection angles.

The micro-brilliant-feeling data input according to necessity is input according to necessity in the case of the color of a paint having a brilliant feeling and containing a brilliant material such as a brilliant pigment having a glittering feeling and an interference action such as scaly aluminum powder, deposited aluminum powder, colored aluminum powder, mica-like iron oxide, mica powder, metal-oxide-covered mica powder, metal-oxide-covered silica flake, or brilliant graphite. The micro-brilliant feeling denotes a specific brilliant texture revealed in the color of a paint containing a brilliant material such as aluminum powder or brilliant mica powder.

It is possible to measure micro-brilliant-feeling data by, for example, a micro-brilliant-feeling measuring instrument and moreover, compare micro-brilliant-feeling sample-color tags with a reference color, select a color tag having a very-similar micro-brilliant feeling, and obtain the micro-brilliant-feeling data of a purposed paint film from the color tag. The micro-brilliant-feeling sample-color tags can be sample-color tags in which color tags obtained by applying brilliant-material-containing paints prepared by changing qualities, particle diameters, and blending quantities of brilliant materials and blending the materials to a substrate and drying the substrate are systematically arranged.

As specific examples of the micro-brilliant-feeling sample-color tags, it is possible to use a booklet and cards showing paint colors of domestic and foreign automobiles classified every fiscal year and automobile maker.

Because micro-brilliant-feeling data, color numbers, or color names are entered in micro-brilliant-feeling sample-color tags, it is possible to extract micro-brilliant-feeling data from the color numbers or color names. Various types of micro-brilliant-feeling data are considered. The present inventors describe in the specification of Japanese Patent Application No. 28414/2000 that micro-brilliant feelings are well matched each other when two brilliant-feeling parameters such as a parameter “MGR” showing particle feeling {perception emitted from irregular non-oriented pattern (random pattern) caused by orientation and overlap of brilliant pigments in paint film} and a parameter “MBV” obtained by digitizing a glittering feeling (perception of irregular fine brightness caused by light regularly-reflected from brilliant pigments in paint film) coincide with each other. Though not restricted, it is possible to preferably use these parameters as micro-brilliant-feeling data.

The above toning class input according to necessity decides a matching degree of a toned-paint color to a reference color (allowable range) and it is possible to change prices of a toned paint in accordance with a toning class. A toning class can be, for example, a color difference between the calorimetric data of a reference color and the paint-color data of a toned paint plate formed by a toned paint.

A paint orderer inputs the colorimetric data of the reference color, type of a toned paint and a necessary quantity of the toned paint, and if necessary, the gloss of a paint film, micro-brilliant-feeling data, and a toning class to a computer terminal Before entering a toning job, a paint orderer can estimate an allowable limit of toning by a designated type of paint in accordance with computer toning using a color-matching computation logic about the colorimetric data of the reference color, change the colorimetric data of the reference color in the toning job to data within an allowable limit of toning by the designated type of paint or change types of paints when it may be difficult to prepare a purposed toned paint with the designated type of paint. It is possible to perform the computer toning using the color-matching computation logic by a computer toning function installed in the computer of the paint orderer and moreover, use the computer toning function of a server computer by connecting the computer of the paint orderer to the server computer.

Step (2)

Step (2) is a step of allowing a paint orderer to select a toning person and give an order for a toning job to the selected toning person.

For a paint orderer to select a toning person, it is possible to use either of the methods described in the following Items (a) and (b).

(a) A method of retrieving order backlogs of a plurality of toning persons by a computer system and selecting a toning person out of the retrieved contents. The above order-backlog data is updated at any time or regularly whenever the data is changed.

(b) A method of opening a toning job to a plurality of toning persons by a computer system, accepting tenders by the computer system, and selecting a toning person in accordance with a tender result.

An order for a toning job is given to the toning person selected as described above by appending the data of an allowable limit of toning by and blending of a designated type of paint through the computer toning using the colorimetric data of a reference color, the type of a paint and a necessary quantity of the paint, and if necessary, the date of delivery, the gloss of a paint film, micro-brilliant-feeling data, toning class, and a color-matching computation logic according to necessity.

An order for a toning job is given by connecting the computer of a paint orderer to that of a toning person. In the case of the above method (a), it is generally necessary to append the above data when giving an order for a toning job. In the case of the above method (b), when the above data is opened to the public together with a toning job by a computer system, it is allowed to omit the appendance of the colorimetric data of the above reference color when giving an order for the toning job.

Step (3)

Step (3) is a step of allowing a toning person to communicate the order-receiving approval of a toning job to a paint orderer and prepare a toned paint.

A toning person checks in the above step (2) whether an error or the like is present in a toning job transmitted from a paint orderer according to necessity. If an error is present, the toning person communicates the error to the paint orderer to obtain a correct toning job. When occasion demands, the toning person can decline the toning job. A method for a toning person to approve order reception of a toning job for a paint orderer is not restricted. However, it is possible to preferably approve order reception by transmitting the order reception approval through a computer.

The toning person can prepare a toned paint matched to the toning job whose order is approved in accordance with a conventionally-publicly-known paint toning method.

To prepare a toned paint, it is also possible to previously decide a toning-end-point allowable range in accordance with a toning class or the like and display that a computer toning system is present at the toning end point when a measured value of a toned paint plate comes into a toning-end-point allowable range.

Moreover, it is preferable to obtain the calorimetric data of a toned paint plate painted with a final toned paint prepared for toning, painting conditions when preparing the toned paint plate, and if necessary, the gloss of a paint film and micro-brilliant-feeling data.

Step (4)

Step (4) is a step of supplying the toned paint obtained in the above step (3) to a paint orderer. to supply the paint to the paint orderer, it is possible to append a toned paint plate painted with a final toned paint, the colorimetric data of the toned paint plate, painting conditions when preparing the toned paint plate, the gloss of a paint film, micro-brilliant-feeling data, and the data for an MSDS according to paint blending and safety indication. To supply the toned paint to the paint orderer, it is possible to preferably use a home delivery service of packages.

Then, a second invention method is described below.

The second invention method is a method including the change of toning jobs when it is difficult to prepare a toned paint according to a toning job in step (2) of the first invention method. The second invention method is the same as the first invention method except that the following step (2a) is included after step (2) and a toning job whose order is given to a selected toning person in step (3) is used as the change-approved toning job in the following step (2a). When the change of the toning job cannot be approved, it is possible to decline the toning job. The second invention method is performed when an allowable limit of toning by a designated type of paint is not previously estimated in step (1) about the colorimetric data of a reference color through the computer toning using a color-matching computation logic.

Step (2a)

Step (2a) is a step of allowing a toning person to estimate an allowable limit of toning by a designated type of paint through the computer toning using a color-matching computation logic about the content of a toning job, transmit the data of the allowable limit of toning by the designated type of paint to a computer terminal of a paint orderer when it is difficult to prepare a toned paint by the toning job, and receive the approval of change to a toning job within the allowable limit of toning. Before computer-toning the content of the toning job sent from the paint orderer, the toning person checks whether an error is present in the toning job according to necessity. If an error or the like is present, the toning person can communicate the error to the paint orderer and obtain a correct toning job.

In the case of the second invention method, the toning person prepares a toned paint suitable for the change-approved toning job in step (3) after the above step (2a).

The second invention method includes the same steps as steps (3) and (4) after the above step (2a).

It is possible to include the following step (5) after step (4) in both the above fist and second invention methods.

Step (5)

Step (5) is a step of determining a toned paint supplied by the above step (4). That is, step (5) is a step of allowing a painter (usually, a paint orderer or a person to whom painting is requested from the paint orderer) to prepare a test paint plate by test-painting the plate with the supplied toned paint, obtain the colorimetric data of the test paint plate, compare the colorimetric data of the test paint plate with a reference color, and determine whether the criterion of the toning end point is satisfied. The above test painting simulates the full-scale painting and therefore, the test painting must be test painting capable of reproducing a paint color in the full-scale painting. Painting conditions for the test painting are not restricted but the conditions can be standard painting conditions when performing painting with the above paint. For example, it is preferable that the above conditions are the same as the painting conditions when preparing the toned pain in the above step (3).

Moreover, the calorimetric data of a reference color used to determine whether a test paint plate satisfies the criterion of the toning end point is the calorimetric data of a reference color for a toning job. For determination, it is also possible to use the data obtained by measuring a reference plate again for convenience' sake. The colorimetric data of a test paint plate is compared with a reference color to determine whether the criterion of the toning end point is satisfied. The criterion can be a criterion (toning class or the like) of the toning end point agreed by both a paint orderer and a toning person.

When a determination result in the above step (5) does not satisfy the criterion of the toning end point, the following step (6) is executed. However, it is impossible to satisfy the criterion of the toning end point even by step (6), it is possible to make the toning person perform toning again.

Step (6)

Step (6) is a step of allowing a computer to display painting conditions for satisfying the criterion of the toning end point and allowing a painter (usually, a paint orderer or person to whom painting is requested from the paint orderer) to prepare a retest paint plate by test-painting the plate with a toned paint in the same step as the above step (5) under the painting conditions, compare the calorimetric data of a retest paint plate with a reference color by a computer, and determine whether the criterion of the toning end point is satisfied. When a determination result in step (6) does not satisfy the criterion of the toning end point, it is possible to repeat step (6) until the criterion is satisfied. Moreover, when it is impossible to satisfy the criterion of the toning end point even by step (6), it is possible to make a toning person perform re-toning.

Painting conditions for satisfying the criterion of the above toning end point include a dilution ratio (painting viscosity), a spray air pressure for spray painting, a distance between a spray gun and a nozzle, an attached quantity of a paint, and a setting time after painting, and it is possible to obtain the above conditions in accordance with the paint-color change data due to the fluctuation of the painting conditions of the toned paint. Moreover, it is possible to obtain the above painting conditions in accordance with the paint-color change data due to the fluctuation of painting conditions of the same type of a paint of a similar color having been accumulated so far instead.

Also in both the first and second invention methods, it is possible to obtain perform full-scale painting after step (4). However, it is preferable to perform full-scale painting under predetermined painting conditions after it is determined that the criterion of the toning end point is satisfied in the above step (5) or (6).

A third invention method includes the following steps (1) to (5).

Step (1)

Step (1) is a step of allowing a paint orderer such as a repair painter to input the colorimetric data of a reference color with which the color of a paint should be matched through toning, the type and a necessary quantity of the paint, and if necessary the date of delivery, gloss of a paint film, micro-brilliant-feeling data, and a toning class to a computer terminal, connect the computer terminal to a server computer of an agent, and enter a toning job.

A step of obtaining measured data of the reference color in step (1) of the third invention method can be executed similarly to the step of obtaining the measure data of the reference color in step (1) of the above first invention method.

A paint orderer inputs the colorimetric data of the above reference color, the type and a necessary quantity of a toned paint, and if necessary the date of delivery, gloss of a paint film, micro-brilliant-feeling data, and a toning class to a computer terminal, connects the terminal to a server computer of an agent, and enters a toning job.

Before entering the toning job, the paint orderer estimates an allowable limit of toning by a designated type of paint through the computer toning using a color-matching computation logic about the colorimetric data of the above reference color. When it may be difficult to prepare a purposed toned paint by the designated type of paint, it is possible to change the colorimetric data of the above reference color in the toning job to data within the allowable limit of toning by the designated type of paint. The computer toning using the above color-matching computation logic can be performed by using a computer toning function installed in the computer of the paint orderer and moreover, it is possible to use the computer toning function by connecting the computer to the server computer of the agent.

Step (2)

Step (2) is a step of allowing an agent to select a toning person and give an order for a toning job to the selected toning person. Before giving the order to the toning person, the agent checks in the above step (1) whether an error is present in the toning job sent from a paint orderer according to necessity. When an error is present, the agent communicates the error to the paint orderer to obtain a correct toning job. When occasion demands, the agent can decline the toning job.

For an agent to select a toning person, it is possible to use either of the methods described in the following Items (a) and (b).

(a) A method of retrieving delivery states between a plurality of toning persons and a paint orderer and order backlogs of the toning persons by a computer system and selecting a toning person in accordance with the retrieval contents. The data of the above delivery states and order backlogs is updated at any time or regularly whenever the data is changed.

(b) A method of opening a toning job to a plurality of toning persons by a computer system, accepting tenders by the computer system, and selecting a toning person in accordance with a tender result.

An order for a toning job is given to the toning person selected as described above by appending the data of an allowable limit of toning by and blending of a designate type of a paint through the computer toning using the colorimetric data of a reference color, the type and a necessary quantity of the paint, and if necessary a toning class, date of delivery, and color-matching computation logic according to necessity.

A method for giving an order for a toning job is not restricted. However, it is preferable to give the order by connecting a server computer of an agent to a computer terminal of a toning person. In the case of the above method (a), it is normally necessary to append the above data to give an order for a toning job. In the case of the above method (b), when the above data is opened to the public together with a toning job by a computer system, it is allowed to omit the appendance of the calorimetric data of the above reference color.

Step (3)

Step (3) is a step of allowing an agent to obtain an order-receiving approval from a toning person and transmit an order-receiving decision to a computer terminal of a paint orderer. Though a method for an agent to obtain an order-receiving approval from a toning person is not restricted, it is preferable to obtain the approval by connecting a computer terminal of the toning person to a server computer of the agent.

When the agent cannot obtain the order-receiving approval from the toning person, it is possible to negotiate order-receiving conditions with the toning person or select other toning person in the above step (2).

Step (4)

Step (4) is a step of allowing a toning person to prepare a toned paint corresponding to the content of the above toning job whose order receiving is approved. It is possible to prepare the toned paint in accordance with the conventionally-publicly-known paint toning method.

To prepare the toned paint, by previously deciding a toning-end-point allowable range in accordance with a toning class or the like, it is possible to display that a computer toning system is present at the toning end point when the measured value of a toned paint plate comes into a toning-end-point allowable range.

Moreover, it is preferable to obtain the colorimetric data of a toned paint plate painted with a final toned paint prepared for toning, painting conditions when preparing the toned paint plate, and if necessary, the gloss of a paint film and micro-brilliant-feeling data.

Step (5)

Step (5) is a step of supplying the toned paint obtained in the above step (4) to a paint orderer. When supplying the toned paint to the paint orderer, it is preferable to append not only the toned paint but also the data of the calorimetric data of a toned paint plate painted with a final toned paint, painting conditions when preparing the toned paint plate, the gloss of a paint film, micro-brilliant-feeling data, MSDS according to paint blending, and safety indication. To supply the toned paint to the paint orderer, it is possible to preferably use a home delivery service of packages.

Then, a fourth invention method is described below.

The fourth invention method is a method including the change of toning jobs when it is difficult to prepare a toned paint by the toning job in step (1) in the above third invention method. The fourth invention method is the same as the third invention method except that the following step (1a) is further included after step (1) and a toning job whose order is given to a selected toning person is regarded as a toning job whose change is approved in the following step (1a). When change of the toning job is not approved, it is possible to decline the toning job. The fourth invention method is normally executed when an allowable limit of toning by a designated type of paint is not previously estimated in step (19 of the third invention method about the calorimetric data of a reference color by the computer toning using a color-matching computation logic.

Step (1a)

Step (1a) is a step of allowing an agent to estimate an allowable limit of toning by a designated type of paint through the computer toning using a color-matching computation logic, transmit the data of an allowable limit of toning by the specified type of the paint to a computer terminal of a paint orderer when it is difficult to prepare a toned paint by a toning job, and receive the approval of change to a toning job within the allowable limit of toning from the paint orderer. The agent checks in step (1) whether an error is present in the toning job sent from the paint orderer according to necessity before applying computer toning t the content of the toning job. When an error is present, it is possible communicate the error to the paint orderer and obtain a correct toning job.

In the case of the fourth invention method, an agent selects a toning person in step (2) after the above step (1a) and gives an order for a toning job whose change is approved in the above step (1a) to the selected toning person. This order giving can be performed by a computer system after connecting a server computer of the agent with a computer terminal of the selected toning person. To perform the order giving, it is possible to transmit the computer toning data estimating the above allowable limit of toning to the toning person.

The fourth invention method includes the same steps as steps (3), (4), and (5) of the above third invention method after the above step (2).

The above third and fourth invention methods can include the following step (6) after step (5).

Step (6)

Step (6) is a step of determining the toned paint supplied by the above step (5). That is, step (6) is a step of allowing a painter (usually, a paint orderer or a person to whom painting is requested from the paint orderer) to prepare a test paint plate painted by test-painting the plate with the supplied toned paint, obtain the colorimetric data of the test paint plate, compare the calorimetric data of the test paint plate with a reference color by a computer, and determine whether the criterion of the toning end point is satisfied. The test painting simulates full-scale painting and it is necessary that the test painting can reproduce a paint color in the full-scale painting. Painting conditions for the test painting are not restricted but it is preferable that the painting conditions can be the standard painting conditions for painting with the paint and are conditions same as the painting conditions used to prepare the toned paint in the above step (4).

Moreover, the colorimetric data of a reference color used to determine whether the criterion of a test-painting-plate toning end point is satisfied is the colorimetric data of the reference color in a toning job. For the above determination, it is also possible to use the data obtained by measuring a reference plate again for convenience' sake. The calorimetric data of a test paint plate is compared with a reference color by a computer to determine whether the criterion of the toning end point is satisfied. In this case, the criterion can be the criterion of the toning end point agreed between a paint orderer and a toning person.

When the determination result in the above step (6) does not satisfy the criterion of the toning end point, the following step (7) is executed. However, it is impossible to satisfy the criterion of the toning end point even by step (7), it is possible to make a toning person perform re-toning.

Step (7)

Step (7) is a step of allowing a computer to display painting conditions for satisfying the criterion of the toning end point and allowing a painter (usually, a paint orderer or a person to whom painting is requested from the paint orderer) to prepare a retest paint plate by test-painting the plate with a toned paint in the same step as the above step (6) under the painting conditions, compare the calorimetric data of the retest paint plate with a reference color by the computer, and determine whether the criterion of the toning end point is satisfied. When a determination result does not satisfy the criterion of the toning end point in step (7), it is possible to repeatedly execute step (7) until the criterion is satisfied. Moreover, when it is impossible to satisfy the criterion of the toning end point even by step (7), it is possible to make a toning person perform toning again.

Painting conditions for satisfying the above criterion of the toning end point are conditions such as a dilution ratio (painting viscosity) by a solvent, a spray air pressure for spray painting, the distance between a spray gun and a nozzle, an attached quantity of a paint, and setting time after painting, which can be obtained in accordance with the data for change of paint colors due to the fluctuation in painting conditions of the above toned paint. Moreover, the painting conditions can be obtained in accordance with the data for change of paint colors due to the fluctuation of the same type of paints of similar colors having been accumulated so far.

In the case of the third and fourth invention methods, it is also possible to perform full-scale painting after step (5). However, it is preferable to perform full-scale painting under predetermined painting conditions after it is determined that the criterion of the toning end point is satisfied in the above step (6) or (7).

A toned-paint order-giving and order-receiving method of the present invention is a toned-paint order-giving and order-receiving method having steps (1) to (3) of the above third and fourth invention methods.

A toned-paint order-giving and order-receiving system of the present invention is a system which can be used to execute steps (1) to (3) and the above third and fourth invention methods and the above order-giving and order-receiving method.

A toned-paint order-giving and order-receiving system of the present invention is an order-giving and order-receiving system including:

(a) a paint-orderer's computer terminal with which the colorimetric data of a reference color with which a toning job such as the color of a paint should be matched through toning, the type and a necessary quantity of the pain, and if necessary the date of delivery, gloss of a paint film, micro-brilliant-feeling data, and toning class is input;

(b) an agent's server computer to which the toning job sent from the paint-orderer's computer terminal is entered and which gives an order for the toning job to a toning person selected out of toning-person data and transmits an order-receiving decision in accordance with the following order-receiving approval of the toning person to an agent's server computer; and

(c) a toning-person's computer terminal for transmitting the order-receiving approval of the toning person about the toning job to the agent's server computer; characterized in that the computer terminal (a), server computer (b), and computer terminal (c) are connected each other by a communication line.

It is allowed that a computer toning function using a color-matching computation logic is provided for the server computer (b) and it is possible to determine whether purposed toning can be made by a designated type of paint so as to match the calorimetric data of a reference color sent as a toning job by the computer toning and obtain the data of an allowable of toning by the designated type of paint.

When the purposed toning cannot be made by the designated type of paint, it is possible to transmit the data of an allowable limit of toning by the designated type of paint to a computer terminal of a paint orderer from an agent and accept the approval of change to a toning job within the allowable limit of toning. When occasion demands, it is possible to change types of paints or cancel a toning job.

A toning job sent from a paint orderer including the information of the colorimetric data of a reference color with which the color of a paint should be matched through toning and the type and a necessary quantity of the paint is entered in a server computer of an agent of the present invention and the server computer can select a toning person out of the toning-person data including order backlogs of a plurality of toning person and delivery states from a toning place up to a painting place of a paint orderer and regularly updated, give an order for the entered toning job to a computer terminal of the selected toning person, and moreover receive the order-receiving approval of the toning person about the order-given toning job, and transmit an order-receiving decision to a computer terminal of the pain orderer.

Embodiments of the Invention

The present invention is more specifically described below by referring to embodiments of the first and second invention methods.

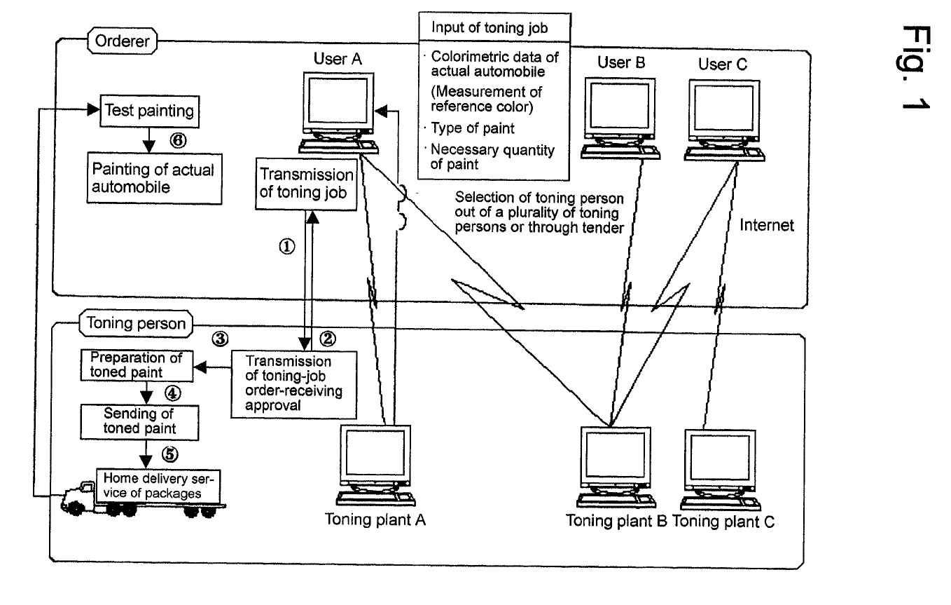

FIG. 1 to be described later is a schematic illustration showing a toned-paint order-giving and supplying method of the present invention. The toned-paint order-giving and supplying method of the present invention is described below in accordance with FIG. 1.

In FIG. 1, a paint orderer inputs actual-automobile colorimetric data obtained by measuring the color of an actual automobile (calorimetric data of a reference color) to be repair-painted to a computer terminal of a paint orderer and the type and a necessary quantity of a paint to be used for painting to the computer terminal of the paint orderer.

The paint orderer selects a toning person to whom an order for the toning jog will be given and gives an order for each toning job to the selected toning person. In this case, order backlogs of a plurality of toning persons can be retrieved from a computer of a toning person and a toning person can be selected in accordance with the retrieval result. An order for a toning job is given by connecting a computer terminal of a paint orderer to a computer of the selected toning person. The toning person receiving the order for the toning job transmits whether to approve order receiving of the toning job to the computer terminal of the paint orderer. When the paint orderer receives from the toning person that the order is not received, the paint orderer can select another toning person.

When approving the order reception, the toning person checks whether any error is present in the toning job to confirm that no error is present. If an error is present, the toning person communicates the error to the paint orderer and corrects the toning job. It is preferable that a plurality of paint blendings, color data and micro-brilliant-feeling data corresponding to the paint blendings, and color characteristic data and micro-brilliant-feeling data of a plurality of primary-color paints are entered in a computer of the toning person and the computer has a computer toning function in which a color-matching computation logic using the paint blendings and these data values works. It is also allowed that the computer of the toning person is a computer capable of using a computer toning function in which a color-matching computation logic works by connecting the computer to a server computer on-line.

After error checking, the toning person obtains the data of an allowable limit of toning by a designated type of paint about the actual-automobile colorimetric data of the toning job in accordance with the computer toning function using a color-matching computation logic according to necessity. When change of toning jobs is necessary in accordance with the data of an allowable limit of toning, the toning person transmits the data of an allowable limit of toning by a designated type of paint to a computer terminal of the paint orderer to obtain the approval of change to a toning job within the toning allowable limit from the paint orderer. Then, the toning person receiving the order prepares a toned paint corresponding to the content of the toning job and supplies the prepared toned paint to the paint orderer by a home delivery service of packages or the like.

The paint orderer serves as a painter or asks a painter to examine whether the color of the toned paint supplied from the toning person matches with a reference color (confirmation painting) and then paints an actual automobile with the toned paint.

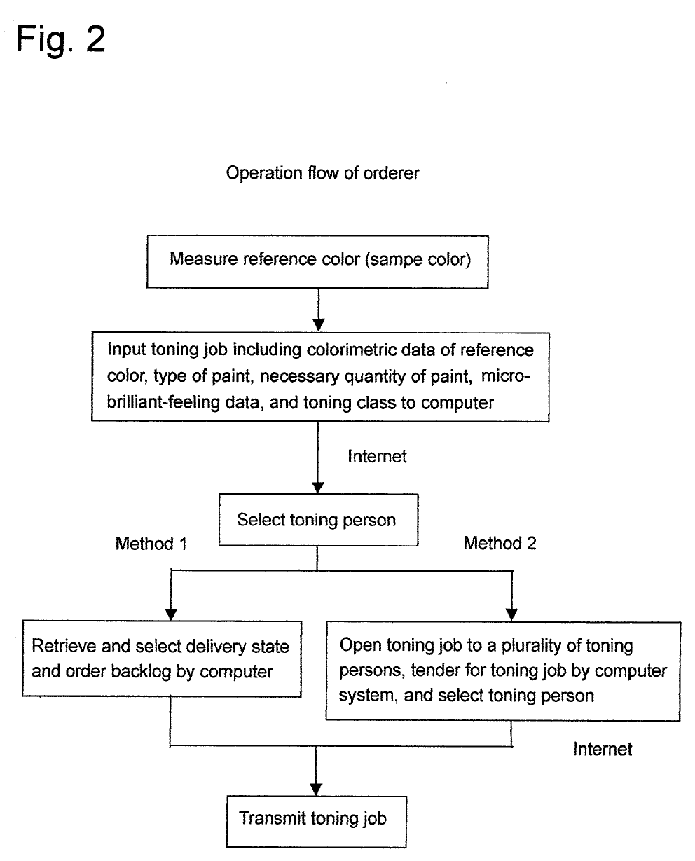

FIG. 2 is an illustration showing a flow of operations performed by a paint orderer in steps (1) and (2).

The paint orderer measures the reference color around a repair-painting portion of an automobile to be repair-painted and inputs a toning job including the type and a necessary quantity of a paint to be applied and if necessary, the gloss of a paint film, micro-brilliant-feeling data, a toning class, date of delivery, to a computer of the paint orderer.

Moreover, the paint orderer selects a toning person to whom an order for the toning job will be given. To select a toning person, it is possible to use a method of selecting a toning person through computer retrieval in accordance with the delivery state between a toning person and a paint orderer, the order backlog of the toning person, toning class, and date of delivery (method 1) or a method of opening a toning job to a plurality of toning persons, tendering for the toning job by a computer system, and selecting a toning person in accordance with the tendering result (method 2). Then, the toning job is transmitted and order-given to the selected toning person by connecting the computer system to a computer of the toning person.

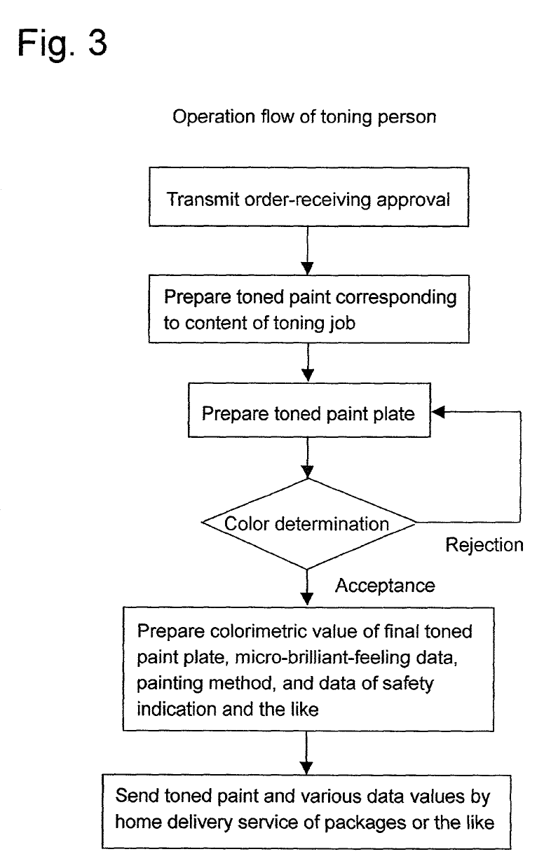

FIG. 3 is an illustration showing a flow of operations performed by a toning person receiving an order for a toning job when approving the order reception.

The toning person communicates approving the order for the toning job to a paint orderer by transmitting the approval to a computer of the paint orderer. The toning person prepares a toned paint corresponding to the content of the toning job and prepares a toned paint plate. Then, the person determines the color of the prepared toned paint plate, continues toning until a measured value of the toned paint plate comes into a predetermined toning-end-point allowable range in accordance with a toning class, and prepares a toned paint. It is possible to control the toning-end-point allowable range in accordance with a measured value of a reference color in a toning job and a toning person can determine acceptance or rejection in accordance with whether a measure value is present in the toning-end-point allowable range. It is also possible to perform determination of acceptance or rejection by making a computer display the toning end point when a measured value of a toned pain plate comes into a toning-end-point allowable range. A toned paint accepted through color determination is sent to a paint orderer by a home delivery service of packages together with the calorimetric data of a final toned paint plate, micro-brilliant-feeling data, painting condition data for toning, and paint safety information (MSDS).

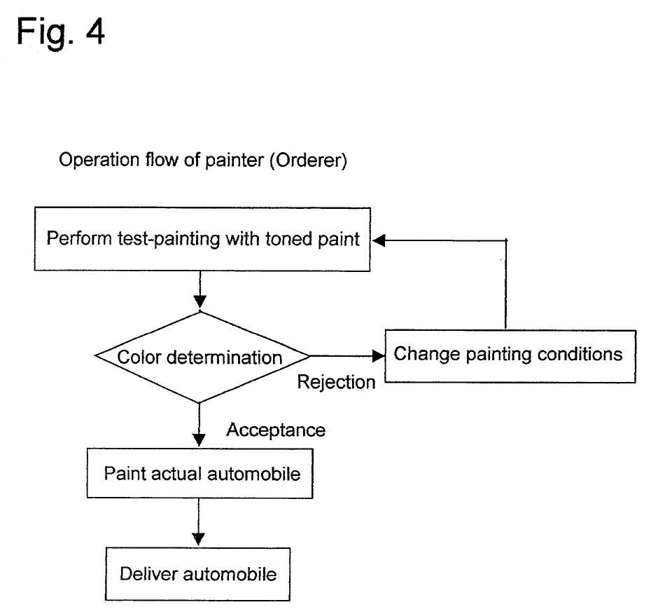

FIG. 4 is an illustration showing a flow of operations performed by a painter (usually, a paint orderer or a person to whom painting is requested from the paint orderer) when examining a toned paint supplied from a toning person according to necessity in a toned-paint order-giving and supplying method of the present invention.

The painter prepares a test paint plate by usually painting the plate with a supplied toned paint by a toning person in accordance with attached painting conditions, compares the colorimetric data of the test paint plate with a reference color by a computer, and determines whether the criterion of the toning end point is satisfied. When a color is not present in an acceptance range, the painter prepares a test paint plate again by changing the painting conditions to painting conditions that may come into the acceptance range. To change painting conditions, it is possible to obtain the information of change portions of the painting conditions from differences of L, a, and b values between the colorimetric data of the test paint plate and the reference color. When color determination is accepted by repeating the above operation, it is possible to paint an actual automobile with the toned paint.

The present invention is more specifically described by using embodiments of the third and fourth invention methods.

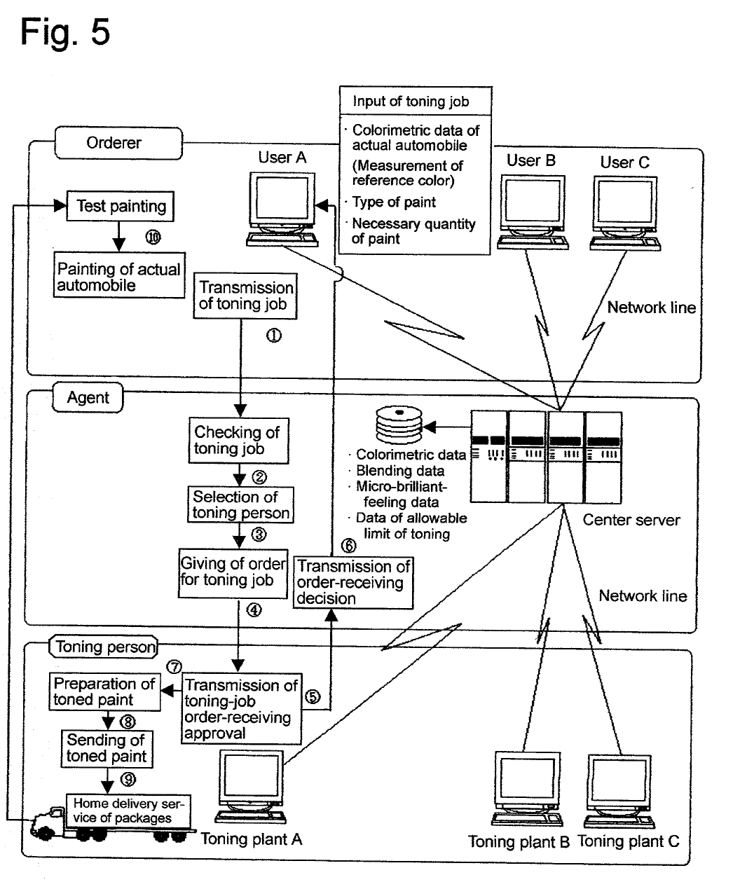

FIG. 5 to be mentioned later is a schematic illustration showing a toned-paint order-giving and supplying method of the present invention. The toned-paint order-giving and supplying method of the present invention is described below by referring to FIG. 5.

In FIG. 5, the colorimetric data (colorimetric data of reference color) obtained by measuring the color of an actual automobile to be repair-painted and the type and a necessary quantity of a paint to be applied are input to computer terminals of a plurality of users (A, B, C, and so on) who are pain orderers and the computer terminals are connected to a server computer (center server) of an agent to enter a toning job. A plurality of paint blendings, color data values and micro-brilliant-feeling data values corresponding to the paint blendings, and color characteristic data values and micro-brilliant-feeling characteristic data values of a plurality of primary-color paints are entered in the sever computer and the sever computer has a computer-toning function in which a color-matching computation logic using these paint blendings and the data values works.

An operator of the server computer of the agent check whether an error is present in the entered toning job and confirms that there is no error. When an error is present, the operator communicates the error to a paint orderer and corrects the toning job including the error. After error checking, the operator obtains the data of an allowable limit of toning by a designated type of paint from the actual-automobile colorimetric data of the toning job in accordance with a computer-toning function using a color-matching computation logic built in the server computer.

Then, the operator selects each toning person about each toning job out of the toning persons input to the server computer and gives an order for each toning job to each selected toning person. In this case, because delivery states between toning persons and a paint orderer and order backlogs of toning persons are input to the server computer, it is possible to select toning persons in accordance with results of retrieving them. When giving an order for a toning job, it is possible to append the data of an allowable limit of toning by a designated type of paint and the blending data of the paint obtained from the computer-toning function according to necessity in addition to the contents of the above toning job.

When a toning person to whom an order for a toning job is given receives the order, the person transmits an order-receiving approval to the server computer. When the person does not receive the order, the person transmits that the order is not received to the server computer. When receiving that the order is not received, the agent selects another toning person. The agent receiving an order-receiving approval by the server computer from the selected toning person transmits the toning person who decides order receiving to a computer terminal of the paint orderer.

It is possible to give and receive an order for a toned paint in accordance with the steps up to the above-described stage.

The toning person receiving the order prepares a toned paint corresponding to the content of the toning job and supplies the prepared toned paint to the paint orderer by a home delivery service of packages or the like.

The paint orderer serves as a painter or asks a painter to examine whether the color of the obtained toned paint matches with a reference color (confirmation painting). After confirming that the color matches with the reference color, the paint orderer paints an actual automobile with the toned paint.

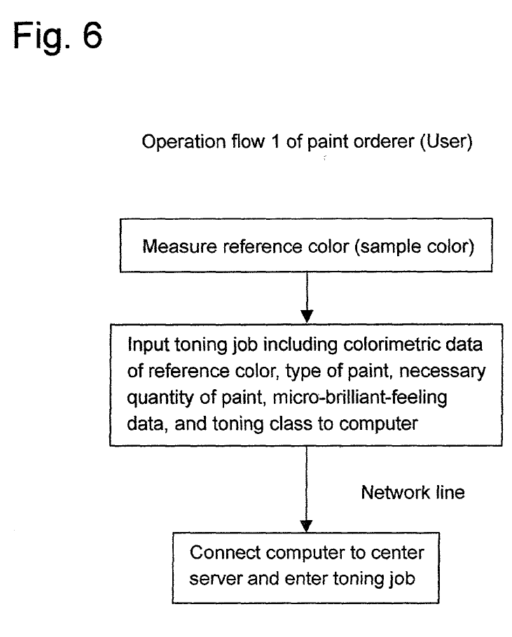

FIG. 6 is an illustration showing a flow of operations to be performed by a paint orderer in step (1).

The paint orderer measures the reference color around a repair painting portion of an automobile to be repair-painted, inputs a toning job including the type and a necessary quantity of a paint to be applied, and if necessary, the gloss of a paint film, micro-brilliant-feeling data, a toning class, and the date of delivery to a computer of the paint orderer, and enters the toning job in a center server of an agent by connecting the computer to the center server through a line.

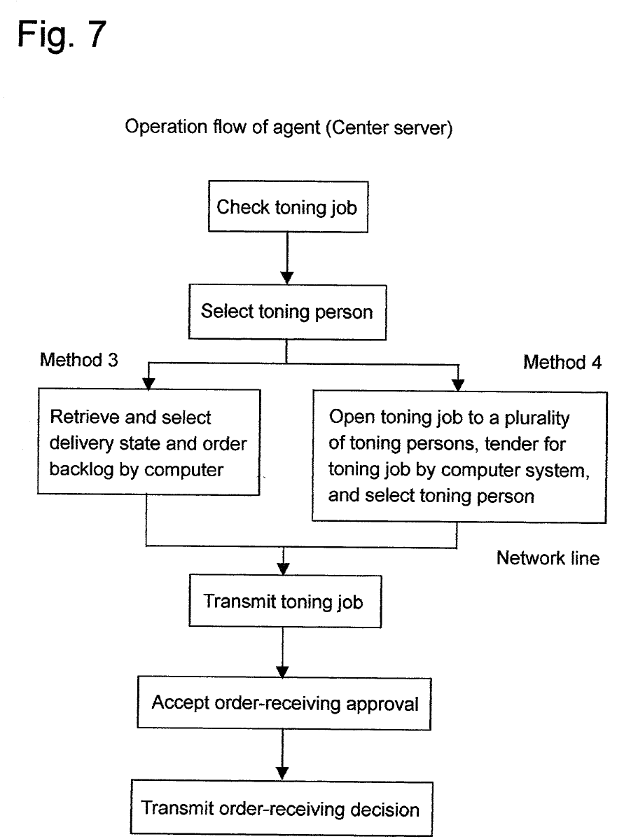

FIG. 7 is an illustration showing a flow of operations to be performed by an agent (center server) in step (2).

The center server checks an entered toning job for errors and then selects a toning person. To select a toning person, it is possible to use a method of selecting a toning person in accordance with a delivery state between the toning person and a paint orderer, order backlog of the toning person, toning class, and date of delivery (method 3) or a method of opening a toning job to a plurality of toning persons, tendering for the toning job by a computer system, and selecting a toning person in accordance with the tendering result (method 4). The center server selects a toning person, obtains an order-receiving approval from the selected toning person through a network line, and then transmits an order-receiving decision to a computer terminal of the paint orderer through a network line. When transmitting the order-receiving decision, it is possible to communicate the toning person to the paint orderer.

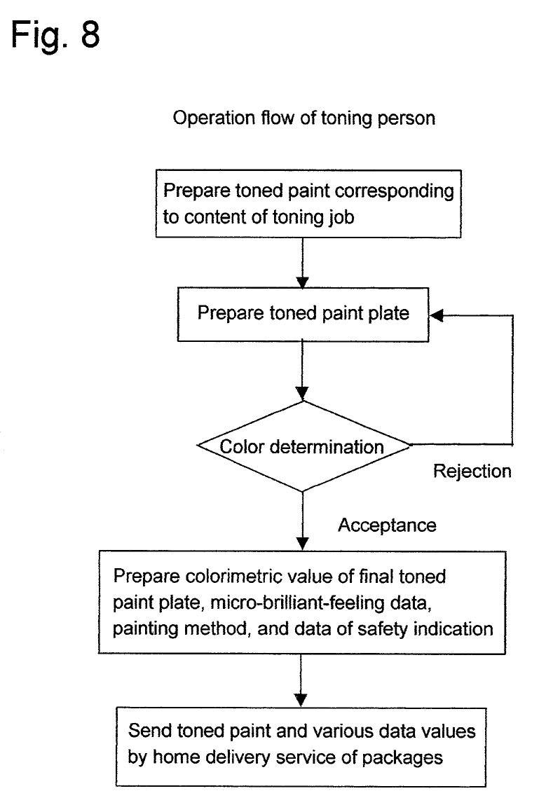

FIG. 8 shows a flow of operations to be performed by a toning person who approves reception of an order for a toning job.

The toning person prepares a toned paint corresponding to the content of a received toning job and prepares a toned paint plate. Then, the toning person determines the color of the prepared toned paint plate and prepares a toned paint until a measured values of the toned paint plate comes into a toning-end-point allowable range predetermined in accordance with a toning class or the like. It is possible to control the toning-end-point allowable range in accordance with a numerical value appended to the toning job. The toning person can determine acceptance or rejection in accordance with whether the measured value is present in the toning-end-point allowable range. It is also possible to determine acceptance or rejection by making a computer display the toning end point when the measured value of the toned paint plate comes into the toning-end-point allowable range. A toned paint accepted through color determination is sent to a paint orderer by a home delivery service of packages or the like together with the colorimetric data of a final toned paint plate, micro-brilliant-feeling data, painting condition data for toning, paint safety information (MSDS), and the final toned paint plate.

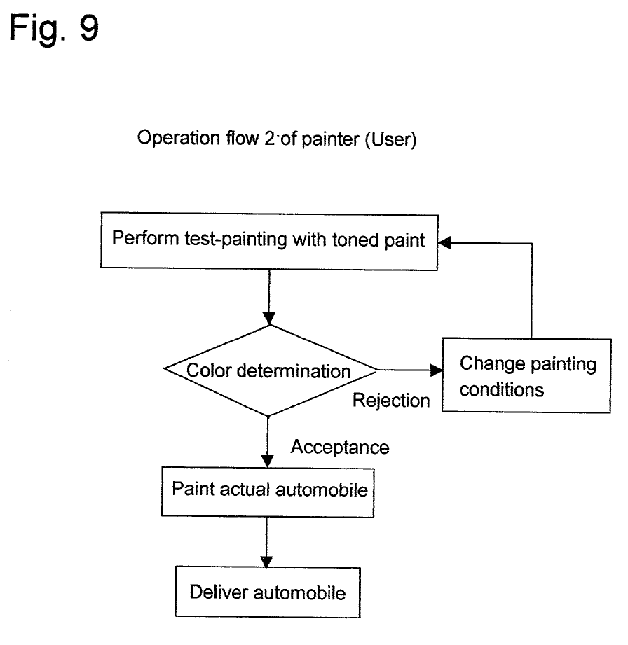

FIG. 9 is an illustration showing a flow of operations to be performed by a painter (usually, a paint orderer or a person to whom painting is requested from the paint orderer) when examining a toned paint supplied from a toning person according to necessity in a toned-paint order-giving and supplying method of the present invention.

The painter normally prepares a test paint plate by painting the plate with the supplied toned paint under painting conditions appended to the toned paint, compares the colorimetric data of the test paint plate with a reference color, and color-determines whether the criterion of the toning end point is satisfied. When the color is not present in an acceptance range, the painter changes the painting condition to a painting condition that may come into the acceptance range and prepares a test paint plate again. To change painting conditions, it is possible to obtain the information of a changed portion of painting conditions from differences of L a, and b values between the colorimetric data of the test paint plate and the reference color. When a color determination is accepted after repeating the above operation, it is possible to paint an actual automobile. After painting the actual automobile, the automobile is delivered to a repair painting requester.

Effect of the Invention

According to a toned-paint order-receiving and supplying method of the present invention, it is unnecessary for a repair painter to perform possession of primary-color paints, inventory control, and toning which have been performed by a repair painter so far and it is possible to cut off toning and provide a quick cost-advantageous toned-paint order-giving and supplying method. Moreover, because the repair painter does not have to perform toning, it is unnecessary to secure an expert toning person, the inventory space of primary-color paints becomes empty, and therefore, this is advantageous from the viewpoint of legal restriction for safety.

Moreover, according to a present invention method, a paint orderer (repair painter) can receive a toned paint from a toning person suitable for a purposed toning job out of a plurality of toning persons.

1. A paint order-giving and supplying method including:
(1) a step of allowing a paint orderer to input a toning job including the calorimetric data of a reference color with which the color of a paint should be matched through toning and the data of the type and a necessary quantity of the paint to a computer terminal;
(2) a step of selecting a toning person, connecting said computer terminal to a computer of the selected toning person, and transmitting said toning job to said selected toning person to give an order for said toning job to said toning person;
(3) a step of allowing said toning person to communicate the order-receiving approval of said toning job to a paint orderer and prepare a toned paint mached with said toning job; and
(4) a step of supplying said toned paint from said toning person to said paint orderer.

2. The method according to claim 1, characterized by further inputting a toning class to said computer terminal in the above step (1).

3. The method according to claim 1 or 2, characterized by retrieving order backlogs of a plurality of toning persons by a computer system and selecting a toning person out of the retrieval contents in the above step (2).

4. The method according to claim 1 or 2, characterized by opening said toning job to a plurality of toning persons by a computer system, accepting tenders by said computer system, and selecting a toning person out of said toning persons in accordance with a tender result in the above step (2).

5. The method according to any one of claims 1 to 4, characterized by including (2a) a step of allowing a toning person to estimate an allowable limit of toning by a designated type of paint through the computer toning using a color-matching computation logic about the content of a toning job, transmit the data of an allowable limit of toning by said designated type of paint to a computer terminal of a paint orderer when it is difficult to prepare a toned paint by said toning job, and receive the approval of change to a toning job within said allowable limit of toning from said paint orderer after the above step (2), characterized in that said toning person prepares a toned paint corresponding to said change-approved toning job in the above step (3).

6. The method according to any one of claims 1 to 5, further including:
(5) a step of allowing a painter to prepare a test paint plate by painting the plate with said toned paint supplied by the above step (4), obtain the colorimetric data of the test paint plate, compare the calorimetric data of the test paint plate with a reference color, and determine whether the criterion of the toning end point is satisfied.

7. The method according to claim 6, characterized by repeating (6) a step of displaying a painting condition which may satisfy the criterion of the toning end point by said computer when the criterion of said toning end point is not satisfied in the above step (5) and allowing a painter to prepare a test paint plate again by test-painting the plate with a toned paint in the same step as the above step (5) under said painting condition, compare the colorimetric data of said test paint plate with a reference color by a computer, and determine whether the criterion of the toning end point is satisfied until the criterion of the toning end point is satisfied.

8. The method according to claim 6 or 7, characterized in that a computer determines that the criterion of the toning end point is satisfied by comparing the calorimetric data of a test paint plate with a reference color and then a painter performs full-scale painting.

9. A toned-paint order-giving and supplying method including:
(1) a step of allowing a paint orderer to input the colorimetric data of a reference color with which the color of a paint should be matched through toning and the type and a necessary quantity of the paint to a computer terminal, connect the computer terminal to a server computer of an agent, and enter a toning job;
(2) a step of allowing said agent to select a toning person and give an order for said toning job to said selected toning person;
(3) a step of allowing said agent to obtain an order-receiving approval from said toning person and transmit an order-receiving decision to a computer terminal of said paint orderer;
(4) a step of allowing said toning person to prepare a toned paint corresponding to the content of said toning job; and
(5) a step of supplying said toned paint to said paint orderer.

10. The method according to claim 9, characterized that a paint orderer is a repair painter.

11. The method according to claim 9 or 10, characterized in that a toning class is further input to said computer terminal in the above step (1).

12. The method according to any one of claims 9 to 11, characterized by retrieving delivery states between toning persons and a paint orderer and the order backlog of the toning person by a computer system, selecting a toning person in accordance with the retrieval content, and giving an order for a toning job to the selected toning person in the above step (2).

13. The method according to any one of claims 9 to 11, characterized by opening a toning job to a plurality of toning persons by a computer system, accepting tenders by the computer system, and selecting a toning person in accordance with a tender result in the above step (2).

14. The method according to any one of claims 9 to 13, characterized by determining whether a measured value of the color of a toned paint plate is present in a color-end-point allowable range when preparing a toned paint and completing toning when the measured value is present in the color-end-point allowable range in step (4).

15. The method according to any one of claims 9 to 14, further including (1a) a step of allowing an agent to estimate an allowable limit of toning by a designated type of paint through the computer toning using a color-matching computation logic about the content of a toning job, transmit the data of the allowable limit of toning by the designated type of paint to a computer terminal of a paint orderer, and accepting the approval of change to a toning job within the allowable limit of toning from the paint orderer after the above step (1); characterized in that said agent selects a toning person and gives an order for said change-approved toning job to the selected toning person.

16. The method according to claim 15, characterized by transmitting the computer toning data estimating an allowable limit of toning by a designated type of paint to selected toning person when giving an order for a change-approved toning job to the selected toning person in the above step (2).

17. The method according to any one of claims 9 to 16, further including (6) a step of allowing a painter to prepare a test paint plate by test-painting the plate with said toned paint supplied by the above step (5), obtain the calorimetric data of the test paint plate, compares the calorimetric data of the test paint plate with a reference color by a computer, and determine whether the criterion of the toning end point is satisfied.

18. The method according to claim 17, characterized by repeating (7) a step of displaying a painting condition which may satisfy the criterion of the toning end point by said computer and allowing a painter to prepare a test paint plate by test-painting the plate with a toned paint in the same step as the above step (6) when the criterion of the toning end point is not satisfied in the above step (6), compare the calorimetric data of the test paint plate with a reference color by said computer, and determine whether the criterion of the toning end point is satisfied until the criterion of the toning end point is satisfied.

19. The method according to claim 17 or 18, further including (8) a step of allowing a computer to compare the calorimetric data of a test paint plate with a reference color and determine that the criterion of the toning end point is satisfied and then, allowing a painter to perform full-scale painting.

20. A toned-paint order-giving and order-receiving method characterized by including:
(1) a step of allowing a paint orderer to input the calorimetric data of a reference color with which the color of a paint should be matched through toning and the type and a necessary quantity of the paint to a computer terminal connect the computer terminal to a server computer of an agent, and enter a toning job;
(2) a step of allowing said agent to select a toning person and give an order for a toning job to the selected toning person; and
(3) a step of allowing said agent to obtain an order-receiving approval from said toning person and transmit an order-receiving decision to a computer terminal of said paint orderer.

21. A toned-paint order-giving and order-receiving system including:
(a) a paint-orderer's computer terminal in which a toning job including the information about the calorimetric data of a reference color with which the color of a paint should be matched through toning and the type and a necessary quantity of the paint are input,
(b) an agent's server computer in which the toning job sent from said paint-orderer's computer terminal is entered and which gives an order for the toning job to a toning person selected out of toning-person data and transmits the order-receiving decision of the toning person to said paint-orderer's computer terminal; and
(c) a toning-person's computer terminal for transmitting the order-receiving approval of the toning person about said toning job to the agent's server computer; characterized in that said computer terminal (a), server computer (b), and computer terminal (c) are connected each other by a communication line.

22. An agent's server computer in which a toning job sent from a paint orderer including the information about the calorimetric data of a reference color with which the color of a paint should be matched through toning and the type and a necessary quantity of the paint is entered and which selects a toning person out of toning-person data including order backlogs of a plurality of toning persons and delivery states from a toning place up to a painting place of the paint orderer, gives an order for said entered toning job to a computer terminal of said selected toning person, and moreover, receives the order-receiving approval of the toning person about the order-given toning job, and transmits an order-receiving decision to a computer terminal of said paint orderer.
